(19) United States
(12) Patent Application Publication
(10) Pub. No.: US 2025/0280981 A1
(43) Pub. Date: Sep. 11, 2025

(54) Stadium Food Tray and Drink Carrier Apparatus

(71) Applicant: Southern Champion Tray, LLC, Chattanooga, TN (US)

(72) Inventors: William H. Jones, Chattanooga, TN (US); Mark Smith, Chattanooga, TN (US); David Chapman, Chattanooga, TN (US)

(73) Assignee: Southern Champion Tray, LLC, Chattanooga, TN (US)

(21) Appl. No.: 19/070,037

(22) Filed: Mar. 4, 2025

Related U.S. Application Data
(60) Provisional application No. 63/561,553, filed on Mar. 5, 2024.

(51) Int. Cl. A47G 23/06; B31B 50/26; B31B 100/00; B31B 120/30; B65D 5/36; B65D 5/50

(52) U.S. Cl. CPC A47G 23/06; B31B 50/26; B65D 5/3657; B65D 5/5021; B31B 2100/00; B31B 2120/302

(57) ABSTRACT

A food and drink container apparatus and method for forming the same is disclosed. The apparatus includes a carrier having a peripheral wall that defines a food and drinks space and that is movable between a collapsed configuration and at least two expanded configurations. A popout holder is located within and is used to modify the configuration of the food and drinks space by being selectively moved between a food tray configuration providing a flat space suitable for securing and holding food and a drink carrier configuration providing an upright support in place of the flat space suitable for securing and holding a drink container. The apparatus may also be configured to provide a combination drink carrier and food tray.

### CROSS-REFERENCE TO RELATED APPLICATION

This application claims the benefit of U.S. Provisional Patent Application No. 63/561,553, filed Mar. 5, 2024, which is incorporated by reference herein in its entirety.

### FIELD

This invention relates to containers for food and drink. More particularly, the present invention relates to a food tray and drink carrier container having two-ply reinforced construction and that provides a popout drink holder and integrated carrying handles.

### BACKGROUND

Currently, many sports stadiums, media venues (e.g., theatres, concert halls, etc.), and other event locations that provide concessions serving food and/or drinks utilize molded fiber carriers, such as container 100 shown in FIG. 1. These containers 100 are provided to customers and are then used by those customers to transport food and drink from one location to another (e.g., from concession stands to customer seats). While useful for this function, containers 100 provide limited utility because they can only be used in a single configuration and provide limited amounts of space. Additionally, containers 100 are not capable of being collapsed and, therefore, often require large amounts of space when being shipped and stored. In an attempt to reduce their overall size to reduce space requirements for shipping and storage, the height of containers 100 may be purposefully limited. This limited height, however, reduces the amount of space available for food and drink, reduces the stability of food and drink carried in the container, and makes carrying food and drink using the container more difficult due to a higher center of gravity.

What is needed is a stadium food tray and drink carrier container that ships flat and that can convert between a food tray mode, a drink carrier mode, and a food tray and drink carrier mode.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

### SUMMARY

The above and other problems are addressed by a unitary blank for use in forming a food tray and drink carrier apparatus configured to be selectively reconfigured between a collapsed configuration and two or more expanded configurations, including a food tray configuration providing a flat space for holding food and a drink carrier configuration providing an upright support in place of the flat space suitable for securing and holding a drink container. The unitary blank includes a bottom panel, a pair of opposing length panels hingedly joined along a bottom edge thereof to the bottom panel, a pair of opposing width panels hingedly joined along a bottom edge thereof to the bottom panel, a support panel hingedly joined and corresponding to opposing ends of each of the length panels, and a folding corner hingedly joined and corresponding to opposing ends of each of the width panels. The length panels are formed by a first length panel portion that is hingedly joined to the bottom panel and a length panel extension portion that is hingedly joined to the first length panel. Each length panel extension portion has dimensions approximating the dimensions of the first length panel portion such that the length panel has a two-ply thickness when the length panel extension portion is folded about the top length joint onto first length panel portion.

In certain cases, a length of each of the length panel extension portions is reduced by a cutback provided at opposing ends thereof. Each cutback extends continuously from a free end of the length panel extension portion, such that the length of the length panel extension portions is less than a length of the first length panel portion and bottom panel. Preferably, an angled connection portion at each opposing end of the length panel extension portions joins an end of each cutback to opposing ends of the first length panel portions.

In certain cases, a popout holder is formed as part of the unitary blank and is defined between a pair of spaced apart contoured edges. Preferably, each contoured edge extends continuously along a portion of the bottom panel and along a portion of one of the length panels or along a portion of one of the width panels, wherein one end of the popout holder is hingedly joined to the bottom panel and an opposing end of the popout holder is hingedly joined to the length panel or width panel so that the popout holder can be moved with respect to the unitary blank while remaining attached to the unitary blank between an out position that provides the food tray configuration providing the flat space for holding food and an in position that provides the drink carrier configuration providing the upright support in place of the flat space for holding a drink container.

Also disclosed is a food tray and drink carrier apparatus. The apparatus includes a carrier that is formed by folding a unitary blank, such as the unitary blank described above, to provide a peripheral wall formed by the pair of opposing length panels, the pair of opposing width panels, the support panels, and the folding corners. A bottom edge of the peripheral wall is foldably joined to the bottom panel. In the collapsed configuration, the peripheral wall is not held upright and is not perpendicular to the bottom panel. On the other hand, in the two or more expanded configurations, the peripheral wall is held upright and perpendicular to the bottom panel to define a food and drinks space that is sized and configured to securely and selectively hold one or more drinks, food, or a combination of one or more drinks and food based on a configuration of the food and drinks space. The apparatus also includes a popout holder that is disposed in and is configured to modify the configuration of the food and drinks space by being selectively moved between a food tray configuration providing a flat space suitable for securing and holding food and a drink carrier configuration providing an upright support in place of the flat space suitable for securing and holding a drink container.

Finally, also disclosed is a method of forming a food tray and drink carrier apparatus, such as the apparatus described above. In the method, a unitary blank such as the unitary blank provided above is provided. A peripheral wall is formed using the unitary blank by folding the width panels about the bottom edge towards the bottom panel, folding the folding corners towards an outward surface of the width panel, folding the support panels towards the corresponding length panel, folding each length panel and the corresponding support panels about the bottom edge towards the bottom panel, and adhering each of the folding corners to one of the support panels.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 is a top perspective view of a conventional molded fiber drink carrier;

FIG. 2 is a top perspective view of a reinforced stadium food tray and drink carrier container according to an embodiment of the present invention;

FIG. 3 is a plan view depicting an unfolded and unglued one-piece blank used for forming the container shown in FIG. 2;

FIG. 4 is a top perspective view depicting the apparatus of FIG. 2 in an expanded full tray configuration having a full food tray section and depicting an optional and removeable insert for a food tray section;

FIG. 5 is a top perspective view depicting the apparatus of FIG. 2 in an expanded drink carrier configuration, where a pair of popout holders provide four drink corners that are each suited to receive and securely hold a drink container;

FIG. 6A is a top perspective view illustrating the apparatus of FIG. 2 in an expanded partial drink carrier and partial food tray configuration, where a single popout holder provides two drink corners that are each suited to receive and securely hold a drink container;

FIG. 6B is a plan view illustrating an apparatus according to an alternative embodiment of the present invention that includes a pair of popout holders on each side of the apparatus such that a total of six drinks may be placed into the apparatus;

FIG. 6C is a top perspective view of a container according to an embodiment of the present invention where a popout holder includes a plurality of tabs for holding various sized drink containers;

FIGS. 7-12 illustrate a process for folding the blank shown in FIG. 3 into a container according to an embodiment of the present invention;

FIG. 13 is a side elevation view showing a width panel of the apparatus of FIGS. 5 and 6A providing a hand space and integrated carrying handle;

FIG. 14 is a top perspective view illustrating the apparatus of FIG. 2 in a partially collapsed configuration;

FIG. 15 is a top perspective view illustrating the apparatus of FIG. 2 in a fully collapsed configuration.

### DETAILED DESCRIPTION

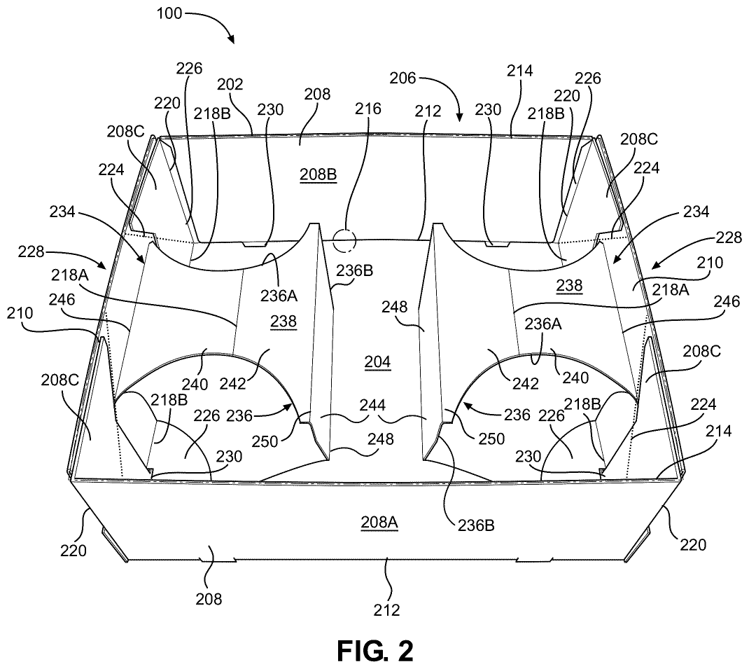

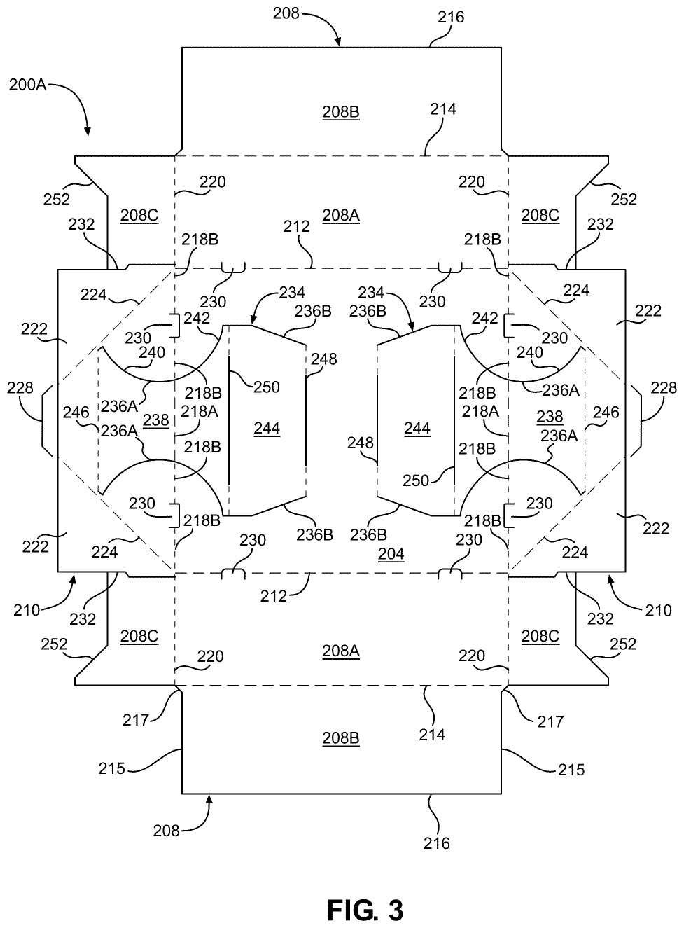

Referring now to the drawings in which like reference characters designate like or corresponding characters throughout the several views, there is shown in FIG. 2 a reinforced paperboard and 100% recyclable stadium food tray and drink carrier container 200 according to an embodiment of the present invention. In FIG. 3, an unfolded and unglued unitary blank 200A that may be folded and glued to form the container 200 is shown. Preferably, once the blank 200A is folded and glued, no further processing is required to form or use container 200. In use, the container 200 provides a food and drinks space 202 that is sized and configured to securely hold drinks, food, or a combination of drinks and food. Space 202 is defined by a bottom panel 204 that is surrounded by a peripheral wall 206. The wall 206 is formed by an opposing pair of length panels 208 hingedly joined along a bottom edge thereof to the bottom panel and an opposing pair of width panels 210 that are also hingedly joined along a bottom edge thereof to the bottom panel. Container 200 may be described herein as being or functioning as a “tray,” “carrier,” etc., which might suggest that the food or drinks carried by such device are in direct contact with the surface of the container. While that may be true in certain cases, it is not true in all cases. In preferred embodiments, container 200 functions as a carrier for food and drink items but is not intended to be used as a bowl or plate that makes direct contact with those food and drink items.

The bottom panel 204 is formed with single-ply (i.e., one layer) construction. On the other hand, the wall 206 has a two-ply (i.e., two layer) construction along substantially its entire length. In the illustrated embodiment, each of the length panels 208 is formed from a first length panel portion 208A that is joined to bottom panel 204 along a bottom length joint 212, and a length panel extension portion 208B that is joined to first length panel portion (208A) along a top length joint 214. Preferably, joint 212 and joint 214 each extend the entire length L of bottom panel 204 (i.e., in a left-to-right direction, as shown in FIG. 3). Preferably, as detailed below, length panel extension portion 208B has dimensions that approximate the dimensions of the first length panel portion 208A. In particular, in preferred embodiments, the opposing left and right ends of length panel extension portion 208B (as seen in FIG. 3) may each be provided with a small cutback 215 such that its overall length is reduced and is slightly less than the length L of bottom panel 204 and first length panel portion 208A. In each case, the cutbacks 215 extend continuously from a free end 216 located at an end of length panel extension portion 208B that is opposite top length joint 214. Then, preferably, an angled connection portion 217 connects an end of the cutbacks 215 of the left and right ends of length panel extension portion 208B to the left and right ends of the length panel extension portion 208B where joints 214 and 220 intersect one another. Preferably, bottom panel 204 and first length panel portion 208A are joined together substantially continuously along their entire length by bottom length joint 212. Similarly, first length panel portion 208A and length panel extension portion 208B are preferably joined together substantially continuously along their entire length along top length joint 214.

Next, in the illustrated embodiment, each opposing end of each width panel 210 includes a folding corner 222 that is joined to the rest of the width panel at joint 224. Each width panel 210 is joined to the bottom panel 204 along a bottom width joint 218 (preferably formed by portions 218A and 218B, discussed below). Preferably, joint 218 extends the entire width W of bottom panel 204 (i.e., in a top-to-bottom direction, as shown in FIG. 3). Length L and width W are approximately equal in the illustrated embodiment but may be different from one another in other embodiments. A support panel 208C extends laterally outwards from each opposing end of first length panel portion 208A and each is joined to the first length panel portion (208A) along joint 220. Preferably, first length panel portion 208A and support panel 208C are joined together substantially continuously along joint 220. Support panel 208C is separated (e.g., by a cut) from the adjacent width panels 210.

In the expanded configuration shown in FIG. 2, wall 206 is securely but removably held perpendicularly to bottom panel 204. A pair of detents 230 may be located along the joints of intersecting surfaces to assist in holding them at an approximate 90-degree angle to one another. For example, in the illustrated embodiment, two detents 230 are provided along each bottom length joint 212 and along each bottom width joint 218. In certain embodiments, a support tab 232 is provided on a bottom of support panel 208C. The support tab 232 may be sized and configured to be received in the detents 230 disposed along bottom width joint 218 when the blank 200A is folded to form the container 200.

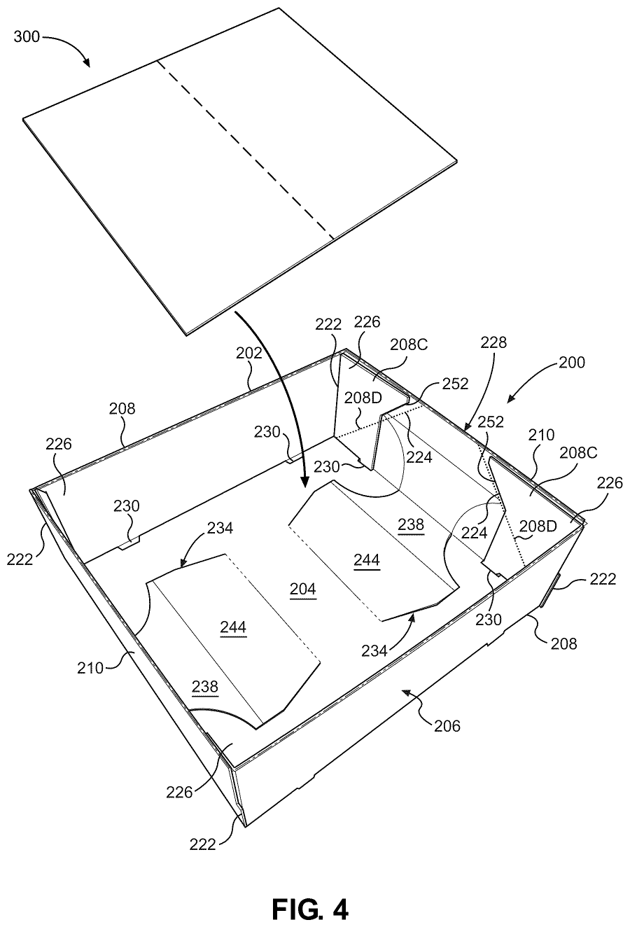

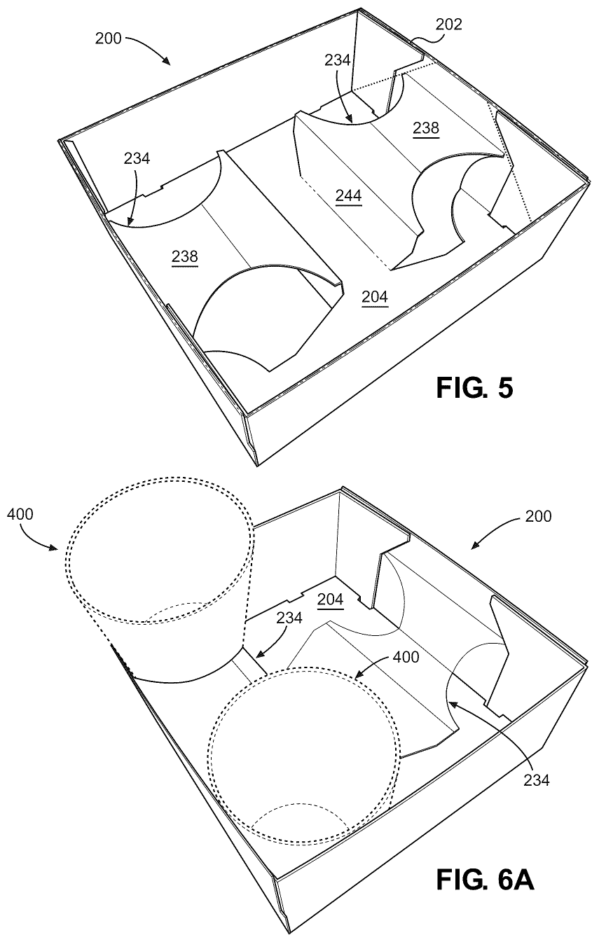

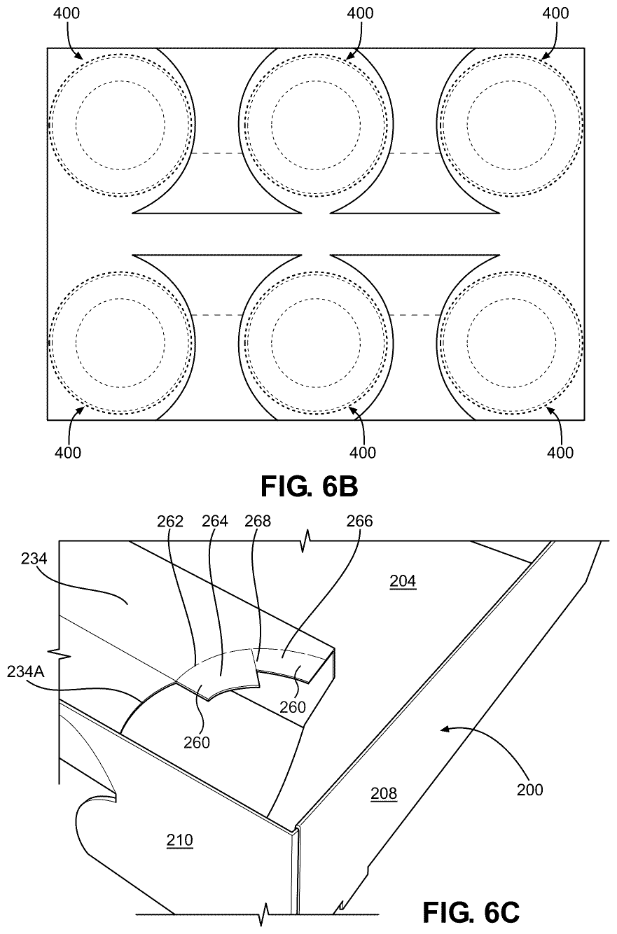

Container 200 is also provided with a pair of popout holders 234 that are each designed to be selectively moved between an “in” position (see FIG. 4) and an “out” position (see FIG. 5) to convert the container between a food tray configuration, a drink carrier configuration, and a food tray and drink carrier configuration (see FIG. 6A). In the food tray configuration, the container 200 includes a flat space suitable for holding food. On the other hand, in the drink dray configuration, the container 200 is configured to hold one or more drink containers. Referring again to FIGS. 2 and 3, each popout holder 234 is formed by and between a pair of profiled edges 236 (preferably formed by portion 236A and portion 236B, discussed below) that extend continuously along a portion of the wall 206 and a portion of the bottom panel 204. Preferably, profiled edges 236 extend either (i) continuously along a portion of the bottom panel 204 and along a portion of both of the length panels 208 or (ii) continuously along a portion of the bottom panel and along a portion of both of the width panels 210.

Preferably, one end of the popout holder 234 is hingedly joined to the bottom panel 204 and an opposing end of the popout holder is hingedly joined to the length panel 208 or width panel 210 so that the popout holder can be moved with respect to the unitary blank 200A while remaining attached to the unitary blank between an out position that provides the food tray configuration providing the flat space for holding food and an in position that provides the drink carrier configuration providing the upright support in place of the flat space for holding a drink container.

The profiled edges 236, along with the bottom 204 and peripheral wall 206, define a “receiver space” 226 that is suitable for holding food (including condiments, etc.) and/or drink of varying sizes. In other cases, such as if two popout holders 234 are placed adjacent one another along the same portion of wall 206, the receiver space 226 may located between those two popout holders (see FIG. 6B). In the illustrated embodiments, the profiled edges 236 are identical for each popout holder 234, but non-identical profiled cuts may be provided in alternative embodiments. Additionally, popout holders 234 are each arranged to provide a provide a receiver space 226 suitable for receiving a drink container (or food items). However, in other embodiments, different profiled cuts may be provided that provide a different type, number, place, or other configurations for food or drink containers or storage.

In the illustrated embodiment, each profiled edge 236 includes a linear portion (236A) and a non-linear portion (236B) connected together at ends thereof to form a continuous linear and non-linear contoured cut formed in the unitary blank. Thus, a portion of profiled edges 236 define an opening having a continuous round profile when the popout holder 234 is in the “in” position shown in FIGS. 2 and 6 (as well as one half of the container 200 shown in FIG. 6A). When a drink container is placed in one of the receiver spaces 226, the space is formed by the wall 206 and portion 236A and is sized and configured to receive and to securely hold the drink container. Preferably, each popout holder 234 is formed as a single unitary component. A top surface 238 of the popout holder 234 is cut partially from the width panel 210 and partially from the bottom panel 204. In particular, the top surface 238 is formed by a wall portion 240 that is cut from one of the width panels 210 of the container 200 and a bottom portion 242 that is cut from the bottom panel 204. The side surface 238 and top surface 240 of the popout holder 234 are hingedly joined together. Therefore, the popout holder 234 can be moved with respect to the unitary blank 200A while remaining attached to the unitary blank between (i) an out position that provides the food tray configuration providing the flat space for holding food, where a portion of the top surface and the side surface are parallel with the bottom panel and each form a portion of the flat space and (ii) an in position that provides the drink carrier configuration providing the upright support in place of the flat space for holding a drink container.

When the blank 200A is unfolded, the wall portion 240 and the bottom portion 242 are separated by a middle portion 218A of the bottom width joint 218 that is located between end portions 218B. Put differently, when the blank 200A is unfolded, the wall portion 240 is located on one side of the middle portion 218A and the bottom portion 242 is located on the other side of the middle portion 218A. In combination, the middle portion 218A and the end portions 218B form the continuous bottom joint 218. The profiled edges 236 also include a second portion 236B that defines a side surface 244 of the popout holder 234 that is cut entirely from the bottom panel 204. When the popout holder 234 is in the “in” position shown in FIG. 2, the top surface 238 of the popout holder is preferably oriented horizontally (i.e., parallel with the bottom panel 204) while the side surface 244 of the popout holder is preferably oriented vertically (i.e., perpendicular to the bottom panel 204). Wall portion 240 is joined to width panel 210 at joint 246, side surface 244 is joined to bottom panel 204 at joint 248. Top surface 238 is joined to side surface 244 at joint 250. Additionally, although depicted as being integrated into the width panel 210 and the bottom panel 204, the popout holders 234 may each be formed entirely separately from the blank 200A, either separately or as a single unit, and then adhered to the blank at the suitable locations.

As noted above, the shape of profiled edges 236 is suitable for creating drink corners that are sized and configured to receive a drink container. However, in other embodiments, differently-shaped profiled edges 236 may be used to provide differently types or sizes of receivers, including for receiving food or condiment containers. For example, as shown in FIG. 6C, in certain embodiments, a plurality of separate and foldable tabs 260 (tab 260A and tab 260B are shown) extend away from and are attached to profiled edge 236 at joint 262, which can be solid or perforated. Tabs 260 are each movable between a contact position that provides a contact surface configured to contact and hold a drink container and a non-contact position where the contact surface does not contact and hold the drink container such that drink containers having outer dimensions (e.g., diameters) of at least two different sizes may be held by the upright support in the drink carrier configuration. Preferably, when the popout holder 234 is in the out or contact position, each tab 260 corresponds to a different sized drink container. For example, first tab 260A, which extends the furthest away from the profiled edge 236 and holds a smaller drink container than the second tab 260B or no tab. Thus, tabs 260 may increase the versatility of the container 200. Preferably, to utilize the different tabs 260, a user simply places the drink container into the receiver space 226. The size-appropriate joint 262 will then bend automatically downward and leave the correct sized tab 260 extended. A cut 268 between the tabs 260 allows each tab to move independently of one another. If desired, a user could remove the unnecessary tab 260 by tearing the tab along joint 262.

Each of the joints between adjoining sections of blank 200A, including joints 212, 214, 218, 220, and 224 may take the form of a crease, complete or partial cut, perforation, or a combination including perforated cuts, cut creases, etc. For example, in the illustrated embodiment, joints 214 and 224 are each cut creases, joints 218 and 220 are formed entirely as perforated cuts. Additionally, in certain cases, end portions of joints 248 and 250 are formed as perforated cuts, while the middle portion between those ends may be a complete cut. As noted above, support panel 208C is separated from the adjacent width panels 210 by a complete cut. In certain versions, profiled edge 236, including portion 236A and portion 236B, are formed by a complete cut. However, in other embodiments, profiled edge 236 may be formed as a perforation to enable the selective creation of pop-out drink container supports. Lastly, in the illustrated embodiment, joint 212 and middle portion 218A are both formed using creases (i.e., without any cutting).

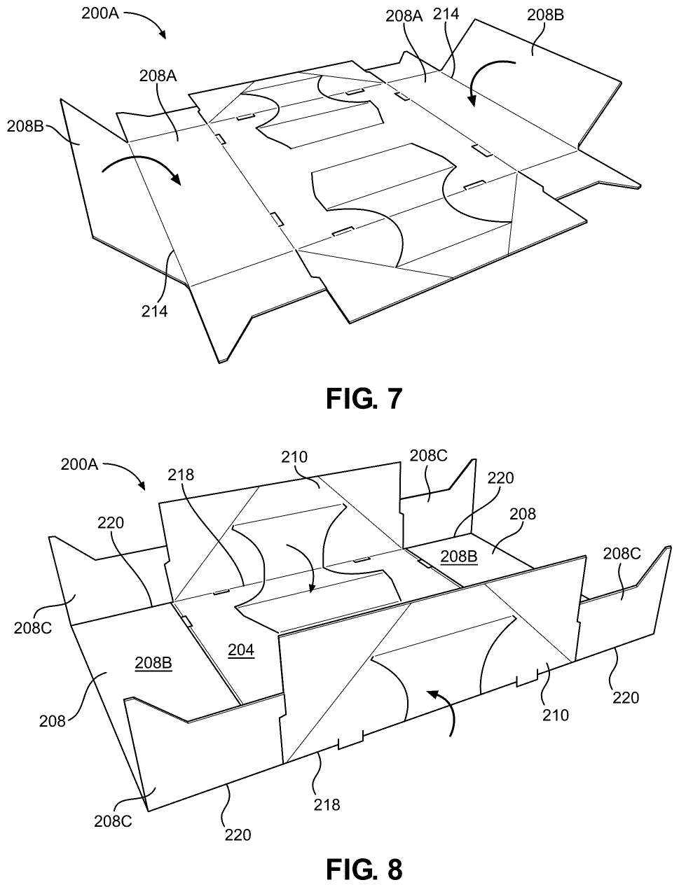

To form a food tray version of container 200 from blank 200A, the peripheral wall 206 is formed first. With specific reference to FIG. 2 and FIG. 7, when forming the wall 206, each of the length panel extension portions 208B is folded inwards (i.e., towards space 202, shown in FIG. 2) along top length joint 214. Each of the length panel extension portions 208B is then folded down and adhered (e.g., glued) to first length panel portion 208A to form the two-ply length panel 208 shown in FIG. 8. With continued reference to FIG. 8, width panels 210 are then folded along joint 218 to be oriented perpendicular to bottom panel 204. Similarly, the support panels 208C are each folded inwards (i.e., towards space 202) along joint 220 to be oriented perpendicularly to bottom panel 204 (and parallel with width panel 210).

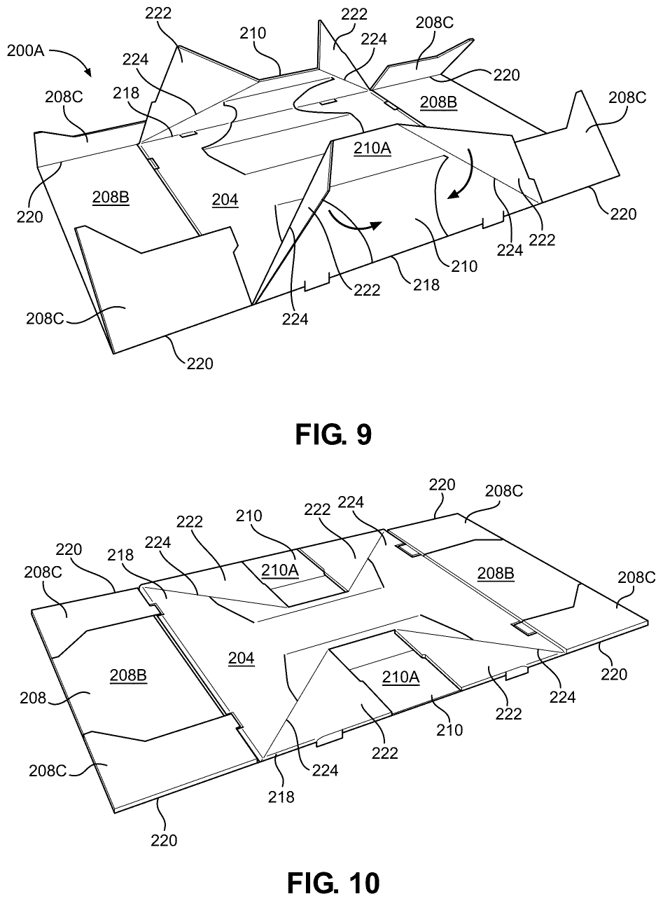

Next, as shown in FIG. 9 and FIG. 10, each of the folding corners 222 is folded outwards (i.e., away from space 202, shown in FIG. 2) along joint 224 and pressed downwards onto an outward facing surface 210A of width panel 210. Also, width panel 210 is folded further along joint 218 and is pressed downwards onto bottom panel 204. At the same time, the support panels 208C are each folded further inwards (i.e., towards space 202, shown in FIG. 2) along joint 220 and are pressed downwards onto an outward facing surface of length panel extension portion 208B.

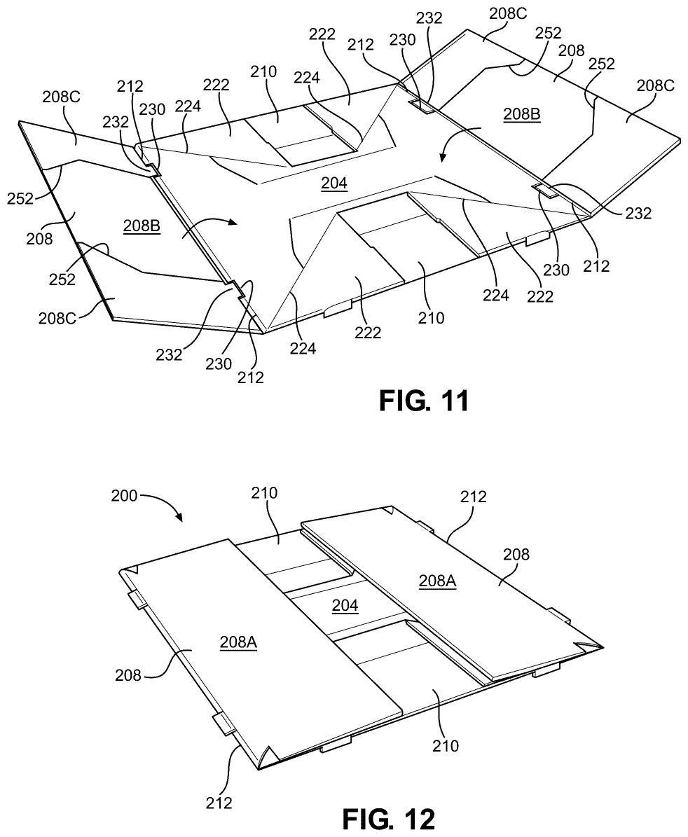

Next, as shown in FIG. 11 and FIG. 12, length panels 208, including support panels 208C, are folded inwards along joint 212. When length panel 208 is folded upwards in this manner, support tab 232 lands on detent 230 along joint 212. Detent 230, and, if present, an extension tab, receives, securely holds and protects support tab 232 from deformation while length panel 208, including panel portions 208A, 208B, and 208C, is first folded along joint 212 and is then pressed downwards onto bottom panel 204 and folding corners 222 of width panel 210. During this step of the construction process, each of the support panels 208C is adhered to one of the folding corners 222. This completes the construction of the container 200. When the construction of the container 200 is completed, it is in the collapsed configuration shown in FIG. 12. Following the procedure described above results in the construction of a full food tray that may be selectively folded out and in between the collapsed configuration shown in FIG. 12 and the expanded configuration shown in FIG. 4.

Importantly, almost the entire wall 206 is formed using two-ply construction, including at each of the reinforced receiver spaces 226 that are formed adjacent joint 220, where length panel 208 intersects width panel 210. As shown best in FIG. 2, the wall 206 includes only a pair of small single-ply portions 228, where support panel 208C does not overlap with the width panel 210. Thus, as noted above, the wall 206 has a two-ply (i.e., two layer) construction along substantially its entire length. In three different embodiments, the wall 206 is “substantially” two-ply when more than 50%, more than 75%, and more than 80% of the peripheral wall is formed using two-ply construction.

In the expanded configuration shown in FIG. 4, support tab 232 and detents 230 are each engaged and assist in holding length panels 208 and width panels 210 perpendicular to bottom panel 204. This configuration may be referred to as a “full tray” configuration. In this case, both popout holders 234 are in the “out” position and provide a large flat area in the bottom of the space 202 that can be used for transporting food items. In this position, part of the popout holders 234 form bottom panel 204 and part of the popout holders form part of width panels 210. In certain instances, to provide further support, an optional and removeable insert 300 may be placed inside of space 202 and on top of bottom panel 204. The insert 300 may be provided with one or more folds 302 to facilitate its insertion into and removal from the space 202 and to allow the insert to be placed into only one half of the space to allow the popout holder 234 on the other side to still be used.

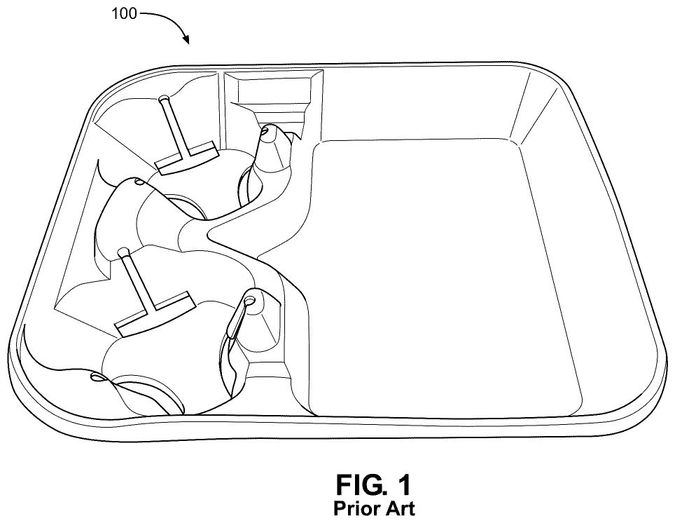

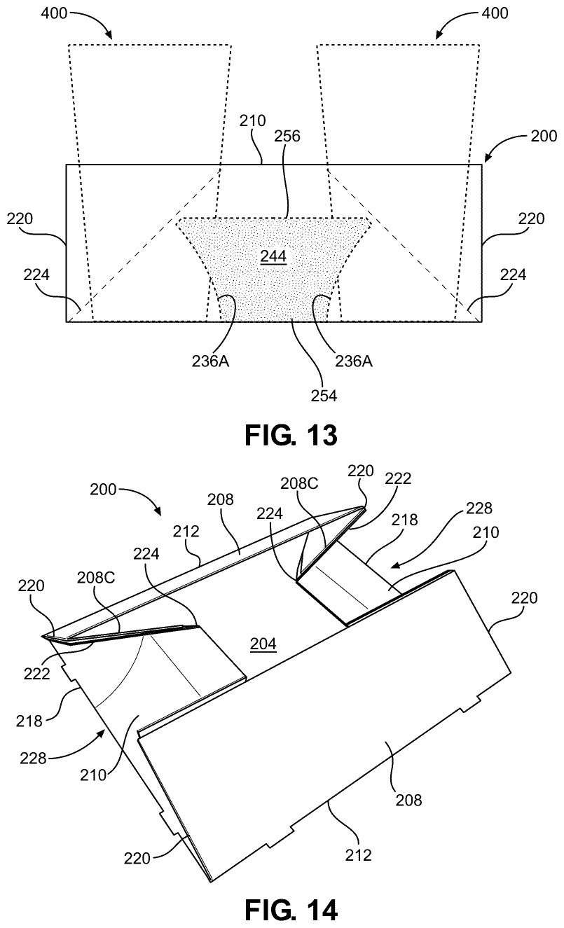

A user may easily convert the container 200 such that the space 202 is used partially or entirely as a drink carrier by raising one or more of the popout holders 234. In FIG. 5, both popout holders 234 are in the “in” position, and this particular container 200 is capable of carrying up to four drink containers in this configuration. This is a “full carrier” configuration. When the popout holders 234 are in this position, the top surface 238 of each is horizontal (i.e., parallel with bottom panel 204) and the side surface 244 of each is vertical (i.e., perpendicular to bottom panel). Then, in FIG. 6, only one of the popout holders 234 is in the in position, and the container 200 is in a “partial tray” configuration or a “partial carrier” configuration that is capable of holding two drink containers 400 and food as well. As shown in FIG. 13, when either of the popout holders is in the in position, a hand space 254 and integrated carrying handle 256 is provided in that width panel 210. Thus, by positioning one or both popout holders in the in position, a single carrying handle or a pair of carrying handles may be provided. Advantageously, the presence of handle 256 and the sizing of hand space 254, places the center of gravity much lower in a customer's hands when using container 200 than when using conventional containers, like container 100 shown in FIG. 1. A higher center of gravity makes balancing and holding a loaded tray more difficult. Therefore, preferably, the center of gravity is as close to the customer's hands as possible. However, since conventional containers are typically carried from the bottom and drink containers are then placed on top of the convention container, the center of gravity in those cases is typically much higher than the customer's hands.

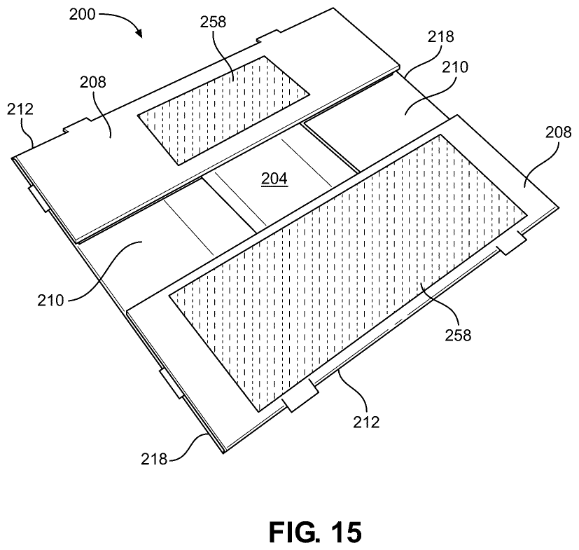

Finally, the container 200 can be partially collapsed and then fully collapsed very quickly. The collapsed configuration allows the container 200 to be stored and transported easily and with minimal space required. To collapse container 200, it is first reconfigured (i.e., partially collapsed) to the “full tray” configuration shown in FIG. 4, with both popout holders 234 in the out position and the space 202 in the full tray configuration. Next, with reference to FIG. 4, FIG. 14, and FIG. 15, the single-ply portions 228 of the width panels 210 are each folded inwards (i.e., towards the space 202), while the support panels 208C are folded along joint 220 and folding corners 222 are folded along joints 224. Once the support panels 208C and folding corners 222 are folded in this manner, they both come to rest in a collapsed configuration on top of the width panel.

It is noted here that, when the support panels 208C are adhered to the folding corners 222, angled cut 252 (FIG. 4) of support panel 208C is aligned with and is preferably placed directly on or immediately adjacent a portion of joint 224. This alignment is shown most clearly in FIG. 4. When the container 200 is transitioned from the expanded configuration shown in FIG. 4 and FIG. 14 to the collapsed configuration shown in FIG. 15, support panel 208C is folded along fold line 208D that is parallel with and co-linear with joint 224 of width panel 210. In FIG. 4, only two joints 224 and fold lines 208D are shown, but an identical pair of each is provided on the opposing width panel 210 and support panels 208C.

Now, as shown in FIG. 14 and FIG. 15, folding width panels 210 along joints 224 in the manner discussed above causes support panel 208C and folding corner 222, which are adhered together, to fold rearwards while the single-ply portion 228 folds forwards about joint 218. This results in width panel 210 resting against bottom panel 204. Then, a support panel 208C and folding corner 222 combination rests on top of each end of width panel 210. Finally, each of the length panels 208 is folded about joint 212 and rests on top of both width panels 210. Each length panel 208 rests on top of one of the support panel 208C and folding corner 222 combinations of each of the width panels 210.

As illustrated in FIG. 15, in certain embodiments, space 258 may be provided on an exterior surface of the wall 206 for promotions, etc. In the illustrated embodiment, a separate advertising space 258 is provided on each of the length panels 208. However, in other embodiments, similar spaces may also be provided on the width panels 210.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A unitary blank for use in forming a food tray and drink carrier apparatus configured to be selectively reconfigured between a collapsed configuration and two or more expanded configurations, including a food tray configuration providing a flat space for holding food and a drink carrier configuration providing an upright support in place of the flat space suitable for securing and holding a drink container, the unitary blank comprising:
a bottom panel;
a pair of opposing length panels hingedly joined along a bottom edge thereof to the bottom panel, where each length panel is formed by:
a first length panel portion that is hingedly joined to the bottom panel; and
a length panel extension portion that is hingedly joined to the first length panel portion at a top length joint, wherein each length panel extension portion that has dimensions approximating the dimensions of the first length panel portion such that the length panel has a two-ply thickness when the length panel extension portion is folded about the top length joint onto first length panel portion;
a pair of opposing width panels hingedly joined along a bottom edge thereof to the bottom panel;
a support panel hingedly joined and corresponding to opposing ends of each of the length panels;
a folding corner hingedly joined and corresponding to opposing ends of each of the width panels.

2. The unitary blank of claim 1 wherein each support panel includes an angled portion extending laterally outwards from the support panel proximate a top edge of the support panel and a support tab disposed along a bottom of the support panel.

3. The unitary blank of claim 2 further comprising a pair of detents located along a joint where the bottom panel intersects with each width panel, each support tab of the length panel being sized and positioned to be inserted into one of said detents when the unitary blank is folded.

4. The unitary blank of claim 1 wherein each of the pair of opposing length panels extends across a substantial entirety of a length of the unitary blank and each of the pair of opposing width panels extends across a substantial entirety of a width of the unitary blank.

5. The unitary blank of claim 1 further comprising a popout holder formed as part of the unitary blank and defined between a pair of spaced apart contoured edges, wherein each contoured edge extends continuously along a portion of the bottom panel and along a portion of one of the length panels or along a portion of one of the width panels, wherein one end of the popout holder is hingedly joined to the bottom panel and an opposing end of the popout holder is hingedly joined to the length panel or width panel so that the popout holder can be moved with respect to the unitary blank while remaining attached to the unitary blank between an out position that provides the food tray configuration providing the flat space for holding food and an in position that provides the drink carrier configuration providing the upright support in place of the flat space for holding a drink container.

6. The unitary blank of claim 5 comprising a popout holder formed on opposing sides of the unitary blank such that each of the contoured edges extend either (i) continuously along a portion of the bottom panel and along a portion of both of the length panels or (ii) continuously along a portion of the bottom panel and along a portion of both of the width panels.

7. The unitary blank of claim 5 wherein the contoured edges of the upright support define a plurality of tabs that are each movable between a contact position that provides a contact surface configured to contact and hold a drink container and a non-contact position where the contact surface does not contact and hold the drink container such that drink containers having outer dimensions of at least two different sizes may be held by the upright support in the drink carrier configuration.

8. The unitary blank of claim 5 wherein each contoured edge includes a linear portion and a non-linear portion connected together at ends thereof to form a continuous linear and non-linear contoured edge formed in the unitary blank.

9. The unitary blank of claim 8 wherein a side surface is formed by the linear portion of the contoured edges and a top surface is formed by the non-linear portion of the contoured edges, wherein the side surface and top surface of the popout holder are hingedly joined together, wherein the popout holder can be moved with respect to the unitary blank while remaining attached to the unitary blank between (i) an out position that provides the food tray configuration providing the flat space for holding food, where a portion of the top surface and the side surface are parallel with the bottom panel and each form a portion of the flat space and (ii) an in position that provides the drink carrier configuration providing the upright support in place of the flat space for holding a drink container, wherein the top surface is parallel with and spaced vertically above the bottom panel and defines a top of the upright support and wherein the side surface is perpendicular to the bottom panel and defines a side of the upright support.

10. The unitary blank of claim 1 wherein a length of each of the length panel extension portions is reduced by a cutback provided at opposing ends thereof, wherein each cutback extends continuously from a free end of the length panel extension portion, such that the length of the length panel extension portions is less than a length of the first length panel portion and bottom panel.

11. The unitary blank of claim 10 wherein an angled connection portion at each opposing end of the length panel extension portions joins an end of each cutback to opposing ends of the first length panel portions.

12. A food tray and drink carrier apparatus comprising:
a carrier formed by folding the unitary blank of claim 1 to provide a peripheral wall formed by the pair of opposing length panels, the pair of opposing width panels, the support panels, and the folding corners, wherein a bottom edge of the peripheral wall is foldably joined to the bottom panel;
wherein, in the collapsed configuration, the peripheral wall is not held upright and is not perpendicular to the bottom panel; and
wherein, in the two or more expanded configurations, the peripheral wall is held upright and perpendicular to the bottom panel to define a food and drinks space that is sized and configured to securely and selectively hold one or more drinks, food, or a combination of one or more drinks and food based on a configuration of the food and drinks space;
a popout holder disposed in and configured to modify the configuration of the food and drinks space by being selectively moved between a food tray configuration providing a flat space suitable for securing and holding food and a drink carrier configuration providing an upright support in place of the flat space suitable for securing and holding a drink container.

13. The apparatus of claim 12 wherein the popout holder is formed by:
a top surface having a wall portion hingedly joined to a bottom portion at a middle portion;
a side surface hinedgely joined to the bottom portion of the top surface; and
a profiled edge located on at least one side of the top surface for at least partially defining a receiver space in the drink carrier configuration,
wherein, when carrier is in the two or more expanded configurations and the popout holder is in the food tray configuration, the wall portion of the top surface is parallel with and co-planar with the peripheral wall and the bottom portion of the top surface and the side surface are both parallel with and co-planar with the bottom panel, and
wherein, when carrier is in the two or more expanded configurations and when the popout holder is in the drink carrier configuration, the wall portion and the bottom portion of the top surface are both parallel with and spaced vertically above the bottom panel and the side surface is parallel with and spaced laterally away from peripheral wall.

14. The apparatus of claim 13 wherein, when the popout holder is in the drink carrier configuration, a hand space and integrated carrying handle is provided by the width panel, and when the popout holder is in the food tray configuration, the popout holder forms part of the peripheral wall.

15. The apparatus of claim 12 further comprising an insert that is sized and configured for removably placement within the container on the bottom panel to provide a two-ply bottom panel.

16. A method of forming a food tray and drink carrier apparatus configured to be selectively reconfigured between a collapsed configuration and two or more expanded configurations, including a food tray configuration providing a flat space for holding food and a drink carrier configuration providing an upright support in place of the flat space for holding a drink container, the method comprising:
providing a unitary blank comprising:
a bottom panel;
a pair of opposing length panels, each length panel having a first end, a second end, and hingedly joined along a bottom edge thereof to the bottom panel, where each length panel is formed by:
a first length panel portion that is hingedly joined to the bottom panel; and
a length panel extension portion that is hingedly joined to the first length panel portion at a top length joint, wherein each length panel extension portion that has dimensions approximating the dimensions of the first length panel portion such that the length panel has a two-ply thickness when the length panel extension portion is folded about the top length joint onto first length panel portion;
a pair of opposing width panels hingedly, each width panel having a first end, a second end, and a bottom edge that is hingedly joined to the bottom panel;
a support panel hingedly joined and corresponding to opposing ends of each of the length panels;
a folding corner hingedly joined and corresponding to opposing ends of each of the width panels,
providing a popout holder disposed in and configured to modify the configuration of the food and drinks space by being selectively moved between the food tray configuration providing the flat space for holding food and the drink carrier configuration providing the upright support in place of the flat space for holding the drink container;
forming a peripheral wall with the unitary blank by:
folding the width panels about the bottom edge towards the bottom panel;
folding the folding corners towards an outward surface of the width panel;
folding the support panels towards the corresponding length panel;
folding each length panel and the corresponding support panels about the bottom edge towards the bottom panel;
adhering each of the folding corners to one of the support panels.

17. The method of claim 16 further comprising reconfiguring the container from the collapsed configuration to a first expanded configuration by raising the peripheral wall into a position perpendicular to the bottom panel.

18. The method of claim 17 wherein the popout holder is formed as part of the unitary blank and is defined between a pair of spaced apart contoured edges, wherein each contoured edge extends continuously along a portion of the bottom panel and along a portion of one of the width panels, wherein one end of the popout holder is hingedly joined to the bottom panel and an opposing end of the popout holder is hingedly joined to the width panel so that the popout holder can be moved with respect to the unitary blank while remaining attached to the unitary blank between an out position that provides the food tray configuration providing the flat space for holding food and an in position that provides the drink carrier configuration providing the upright support in place of the flat space for holding a drink container, the method further comprising reconfiguring the container from the first expanded configuration to a second expanded configuration by moving the popout holder between (i) the food tray configuration, where the upright support is in an out position where a portion of a top surface and a side surface of the upright support are parallel with the bottom panel and each form a portion of the flat space, and (ii) the drink carrier configuration, where the upright support is in an in position where the top surface is parallel with and spaced vertically above the bottom panel and defines a top of the upright support and where the side surface is perpendicular to the bottom panel and defines a side of the upright support.

19. The method of claim 18 wherein the contoured edges define a plurality of tabs that are each movable between a contact position that provides a contact surface configured to contact and hold a drink container and a non-contact position where the contact surface does not contact and hold the drink container such that drink containers having outer dimensions of at least two different sizes may be held by the upright support in the drink carrier configuration, the method comprising moving at least one of the plurality of tabs to reconfigure the upright support from a food tray and drink carrier apparatus suitable for contacting and holding a drink container having a first outer dimension to a food tray and drink carrier apparatus suitable for contacting and holding a drink container having a second and different outer dimension.

20. The method of claim 16, the unitary blank further comprising a pair of detents located along a joint where the bottom panel intersects with each width panel and a support tab disposed along a bottom of the support panel, the method further comprising, as the length panel and corresponding support panels are folded about the bottom edge towards the bottom panel, inserting one of said support tabs of the length panel into each detent.
